(19) United States
(12) Patent Application Publication
(10) Pub. No.: US 2007/0249753 A1
(43) Pub. Date: Oct. 25, 2007

(54) Melt-spinning grains containing thermal-stable phase-change material and preparation method thereof

(75) Inventors: Yen-Hsi Lin, Taipei City (TW); Cheng-Chu Lin, Taoyuan Hsien (TW); Jian-Min Lin, Benchiao City (TW)

Correspondence Address: MARSHALL, GERSTEIN & BORUN LLP, 233 S. WACKER DRIVE, SUITE 6300, SEARS TOWER, CHICAGO, IL, 60606, US

(73) Assignee: TAIWAN TEXTILE RESEARCH INSTITUTE, Tu-Chen City (TW)

(21) Appl. No.: 11/646,998

(22) Filed: Dec. 28, 2006

(30) Foreign Application Priority Data
Apr. 20, 2006 (TW) 95114169

(51) Int. Cl. C08K 9/00

(52) U.S. Cl. 523/200; 523/205

(57) ABSTRACT

A micro-capsulated thermal-stable phase-change polymer is mixed with a melt-spinning polymer, and melt-spinning grains are obtained after processing the mixture described above. The thermal-stable phase-change polymer has a polyether main chain and two fatty acyl terminals. The polyether main chain is polyethylene glycol or polytetramethylene glycol. The two fatty acyl terminals are preferably stearoyl group, palmitoyl group, or lauroyl group.

### RELATED APPLICATIONS

The present application is based on, and claims priority from, Taiwan Application Serial Number 95114169, filed Apr. 20, 2006, the disclosure of which is hereby incorporated by reference herein in its entirety.

### BACKGROUND

1. Field of Invention

The present invention relates to melt-spinning grains. More particularly, the present invention relates to melt-spinning grains containing a thermal-stable phase-change material (PCM) and preparation method thereof.

2. Description of Related Art

A phase-change material (PCM) is a substance capable of storing or releasing large amount of latent heat when being melted or solidified at a certain temperature range. Paraffinic hydrocarbons (CₙH₂ₙ₊₂) is a common PCM featured by its ability of stabilizing system temperature by releasing or absorbing a large amount of latent heat, so PCM can be applied to temperature-adaptable textile.

There are two methods of integrating PCM into textile. The first method is to have PCM encapsulated in microcapsules and then coated on the surface of textile fiber or textile. The second method is to have PCM encapsulated in microcapsules and added to an acrylic spinning solution, then a wet-spinning process is performed to form acrylic fiber. The first method is to have micro-capsulated PCM coated on the surface of textile fibers or textile by a post arrangement and process. Therefore, the PCM is easily detached so its range of application is limited. The second method goes through a wet-spinning process which requires a solvent so solvent recycling and other related environmental problems are issues to be concerned.

Among those common artificial fibers, such as acrylic fibers, nylon fibers, polyester fibers, polypropylene fibers and other related fibers, only acrylic fibers can be obtained by wet-spinning process, other artificial fibers require a melt-spinning process. Because the temperature range for melt-spinning is about 200-380° C. and the obtained fibers should be able to withstand pressure up to 3,000 PSI. Thermogravimetric analysis on regular PCMs, e.g. long hydrocarbon chain and carboxylic ester disclosed in US publication No. 2004/0026659, shows the maximum weight-loss temperature for regular PCM is about 230° C. Therefore, PCM will be pyrolyzed at the melt-spinning temperature if a melt-spinning process is to be used. A lot of research is conducted to solve this problem.

A stable composition comprising PCM, antioxidant and thermal stabilizer is disclosed in U.S. Pat. No. 6,689,466 “Stable phase-change materials for use in temperature regulating synthetic fibers, fabrics and textiles”. The antioxidant and thermal stabilizer are to improve antioxidative ability and thermal stability of PCM, so the PCM can be added to melt-spinning grains.

As disclosed in U.S. Pat. No. 6,793,856 “Melt spinable concentrate pellets having enhanced reversible thermal properties,” PCM is micro-capsulated or concentrated in melt-spinning grains. The method of manufacturing melt-spinning grains is to melt a dispersion polymer, add a PCM which contains 30-40 wt % water, heat up to remove water, cool down and blend together the obtained PCM containing dispersion polymer solid and a thermoplastic polymer to obtain a melt-spinning grain containing 10-30 wt % PCM. The above mentioned dispersion polymer should be a low molecular weight polymer with chemical affinity to the PCM, and the above mentioned thermoplastic polymer should be a high molecular weight polymer with chemical affinity to the dispersion polymer.

Related patent such as TW post-granted publication No. 587110, “Multi-component fibers having enhanced reversible thermal properties and methods of manufacturing thereof”, disclosed the method of manufacturing multi-component fiber. The multi-component fiber comprises, at least, two types of composite fibers such as island-in-sea fiber and core-sheath fiber.

### SUMMARY

A manufacturing method of melt-spinning grains containing thermal-stable PCM is provided. Powder of microcapsules containing thermal-stable PCM, melt-spinning polymer and dispersion agent are mixed in a ratio, preferably 10-50:40-90:0.5-5, more preferably 30:69:1. Process the above mentioned melt-spinning mixture to obtain the melt-spinning grains. The thermal-stable PCM is a type of polyether fatty-acid ester which solid-liquid phase-change temperature is 0-80° C. and the maximum weight-loss temperature is higher than 350° C.

In accordance with an embodiment of the invention, the polyether main chain of the polyether fatty-acid ester is polyethylene glycol or polytetramethylene glycol. The molecular weight of polyethylene glycol is preferably from about 200 to about 20,000 g/mole, the molecular weight of polytetramethylene glycol is preferably from 650 to 3,000 g/mole. Each of the two fatty acyl terminals of the polyether fatty-acid ester preferably contains 4-28 carbons. The two fatty acyl terminals are preferably stearoyl group, palmitoyl group, or lauroyl group.

In accordance with another embodiment of the invention, the above mentioned melt-spinning polymer can be polypropylene, polyethlyne, acrylic resin, thermoplastic polyurethane, nylon, or polyester.

In accordance with another embodiment of the invention, the dispersion agent includes a lubricant.

Melt-spinning grains containing a thermal-stable PCM is provided. The weight percentage of microcapsules containing the PCM in the mixture of microcapsule powder, melt-spinning polymer and dispersion agent is about 10 to about 50 wt %. The thermal-stable PCM is a type of polyether fatty-acid ester which solid-liquid phase-change temperature is 0-80° C. and the maximum weight-loss temperature is higher than 350° C.

In accordance with an embodiment of the invention, the polyether main chain of the polyether fatty-acid ester is polyethylene glycol or polytetramethylene glycol. The molecular weight for polyethylene glycol is preferably from about 200 to about 20,000 g/mole, the molecular weight for polytetramethylene glycol is preferably from about 650 to about 3,000 g/mole. Each of the two fatty acyl terminals of the polyether fatty-acid ester preferably contains 4-28 carbons. The two fatty acyl terminals are preferably stearoyl group, palmitoyl group, or lauroyl group.

In accordance with another embodiment of the invention, the above mentioned melt-spinning polymer can be polypropylene, polyethylene, acrylic resin, thermoplastic polyurethane, nylon, or polyester.

In accordance with another embodiment of the invention, the dispersion agent includes a lubricant.

It is to be understood that both the foregoing general description and the following detailed description are by examples, and are intended to provide further explanation of the invention as claimed.

### DETAILED DESCRIPTION

Accordingly, melt-spinning grains containing a thermal-stable PCM and a preparation method thereof are provided.

### Thermal-Stable PCM

The thermal-stable PCM used here is a type of polyether fatty-acid ester which solid-liquid phase-change temperature is 0-80° C. and the maximum weight-loss temperature is around 350° C. The polyether main chain of the polyether fatty-acid ester is preferably polyethylene glycol (PEG) or polytetramethylene glycol (PTMG). The molecular weight for polyethylene glycol is preferably from about 200 to about 20,000 g/mole, and the molecular weight for polytetramethylene glycol is preferably from about 650 to about 3,000 g/mole. Each of the two fatty acyl terminals of the polyether fatty-acid ester preferably contains 4-28 carbons. The fatty acyl group can be, for example, stearoyl group (18 carbons), palmitoyl group (16 carbons), or lauroyl group (12 carbons). Table 1 and Table 2 show maximum weight-loss temperatures for several polyether fatty-acid esters.

TABLE 1
melting points and maximum weight-loss temperatures for
several polyethylene glycol fatty-acid esters.

| Polyether fatty-acid | Melting Point | Maximum weight-loss |
|---|---|---|
| ester | (° C.) | temperature (° C.) |
| PEG 6000-DS | 57.6 | 394 |
| PEG 6000-DL | 57.6 | 389 |
| PEG 4000-DS | 55.0 | 390 |
| PEG 4000-DL | 54.4 | — |
| PEG 2000-DS | 49.5 | 389 |
| PEG 1500-DS | 44.8 | 393 |
| PEG 1000-DS | 38.3 | — |
| PEG 600-DS | 38.5 | 389 |
| PEG 400-DS | 45.9 | 387 |
| PEG 200-DS | 45.0 | 388 |

Note:
PEG (polyethylene glycol),
DS (di-stearoate),
DL (di-lauroate)

TABLE 2
melting points and maximum weight-loss temperatures for
several polytetramethylene glycol fatty-acid esters.

| Polyether fatty-acid | Melting point | Maximum weight-loss |
|---|---|---|
| ester | (° C.) | temperature (° C.) |
| PTMG 3000-DS | 29.0 | — |
| PTMG 2000-DS | 28.9 | 399 |
| PTMG 2000-DL | 26.4 | 391 |
| PTMG 1800-DS | 29.6 | — |
| PTMG 1800-DL | 24.3 | — |
| PTMG 1000-DS | 31.0 | — |
| PTMG 850-DS | 33.4 | 376 |
| PTMG 850-DP | 29.3 | — |
| PTMG 850-DL | 16.3 | — |

Note:
PTMG (polytetramethylene glycol),
DS (di-sterarate),
DL (di-lauroate),
DP (di-palmitoate)

### Manufacturing Method of Micro-Capsulated Thermal-Stable PCM

The above mentioned thermal-stable PCM is heated and melted into liquid phase. Acrylic monomer and catalyst for polymerization are added together, then an emulsifier solution is also added and a high-speed homo mixer is used to mix the above components by high speed stirring. The components are heated up to perform polymerization reaction to obtain micro-capsulated thermal-stable PCM emulsion. A separatory funnel is used to extract microcapsules from the upper layer of the solution. Then, a low molecular weight surfactant is added so the microcapsules and water can form a microcapsule solution. The weight ratio for microcapsules and water is around 115-125:900. Finally, the solution is dried and a solid powder can be obtained by, for example, spray drying, freeze drying or reduced pressure drying.

The above mentioned catalyst can be, for example, benzoyl peroxide, potassium persulfate (K₂S₂O₈), or ammonium persulfate ((NH₄)₂S₂O₈). The above mentioned emulsifier can be a high molecular weight surfactant, for example, polyvinyl alcohol, or poly (methylvinylether/maleic anhydride) copolymer (Chemical formula 1). The above mentioned small molecular weight surfactant can be p-C₆H₄—(SO₃Na)₂.

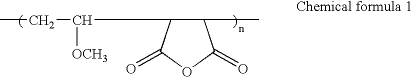

### Manufacturing Method of Melt-Spinning Grains Containing Thermal-Stable PCM

The above mentioned micro-capsulated thermal-stable PCM, a melt-spinning polymer and a dispersion agent are mixed together and then a twin-screw extruder is used to perform hot melting, extrusion molding and particle cutting processes to obtain melt-spinning grains containing thermal-stable PCM. The melt-spinning grains containing micro-capsulated thermal-stable PCM can be combined with other melt-spinning resin materials to form composite fiber such as island-in-sea fiber or core-sheath fiber. The above process is apparent to those skilled in the art, so the detailed steps will not be mentioned here.

The above mentioned melt-spinning polymer can be polypropylene (PP), polyethylene (PE), acrylic resin, thermoplastic polyurethane (TPU), nylon, or polyester.

The above mentioned dispersion agent can be, for example, polyolefin wax.

The ratio for micro-capsulated thermal-stable PCM, melt-spinning polymer and dispersion agent is preferably 10-50:40-90:0.5-5, and more preferably 30:69:1.

The above mentioned twin-screw extruder is a regular twin-screw extruder, this invention does not require any specific twin-screw extruder.

An embodiment of the invention is provided in accordance with the manufacturing method of melt-spinning grains containing thermal-stable PCM mentioned above. 1 Kg polypropylene, 200 g thermal-stable PCM microcapsule powder and 6 g lubricant are stirred and mixed for 10 minutes. The obtained mixture is added to twin-screw extruder, the mixture is heated and melted, the melt is extruded to cooling water, a particle cutting process is performed to obtain polypropylene grains containing thermal-stable PCM. The obtained polypropylene grains containing thermal-stable PCM and material such as nylon or polyester can be mixed together to obtain core-sheath fiber by twin-screw extruder.

Accordingly, since the maximum weight-loss temperature of the thermal-stable PCM used in the invention is higher than 350° C., the thermal-stable PCM is suitable to be used in manufacturing melt-spinning grains. Because the dry powder of micro-capsulated thermal-stable PCM contains very limited water, it does not take too much time to remove water to mix with high molecular weight polymer when manufacturing melt-spinning grains. Therefore, melt-spinning grains containing thermal-stable PCM microcapsules are suitable for manufacturing melt-spinning fibers composed of only one polymer or composite fibers with more than two polymers. In addition, the dry powder of micro-capsulated thermal-stable PCM contains very limited water, so more micro-capsulated thermal-stable PCM can be added to obtain melt-spinning fibers with higher heat capacity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing method of melt-spinning grains containing thermal-stable phase-change material, comprising:
mixing powder of microcapsuls encapsulating a thermal-stable phase-change material, a melt-spinning polymer and a dispersion agent to form a melt-spinning mixture, wherein the thermal-stable phase-change material includes polyether fatty-acid ester which solid-liquid phase-change temperature is 0-80° C. and the maximum weight-loss temperature is higher than 350° C.; and
processing the melt-spinning mixture to form melt-spinning grains.

2. The manufacturing method of melt-spinning grains containing thermal-stable phase-change material of claim 1, wherein the polyether main chain of the polyether fatty-acid ester is polyethylene glycol or polytetramethylene glycol.

3. The manufacturing method of melt-spinning grains containing thermal-stable phase-change material of claim 2, wherein the molecular weight of the polyethylene glycol is from about 200 to about 20,000 g/mole.

4. The manufacturing method of melt-spinning grains containing thermal-stable phase-change material of claim 2, wherein the molecular weight of the polytetramethylene glycol is from about 650 to about 3,000 g/mole.

5. The manufacturing method of melt-spinning grains containing thermal-stable phase-change material of claim 1, wherein each of two fatty acyl terminals of the polyether fatty-acid ester contains 4-28 carbons.

6. The manufacturing method of melt-spinning grains containing thermal-stable phase-change material of claim 1, wherein each of two fatty acyl terminals of the polyether fatty-acid ester is stearoyl group, palmitoyl group, or lauroyl group.

7. The manufacturing method of melt-spinning grains containing thermal-stable phase-change material of claim 1, wherein the melt-spinning polymer is polypropylene, polyethlyne, acrylic resin, thermoplastic polyurethane, nylon, or polyester.

8. The manufacturing method of melt-spinning grains containing thermal-stable phase-change material of claim 1, wherein the dispersion agent includes a lubricant.

9. The manufacturing method of melt-spinning grains containing thermal-stable phase-change material of claim 1, wherein the weight ratio for the powder of microcapsuls encapsulating a thermal-stable phase-change material, the melt-spinning polymer and the dispersion agent is 10-50:40-90:0.5-5.

10. The manufacturing method of melt-spinning grains containing thermal-stable phase-change material of claim 1, wherein the melt-spinning mixture is processed by a twin-screw extruder to form the melt-spinning grains.

11. The manufacturing method of melt-spinning grains containing thermal-stable phase-change material of claim 1, wherein the melt-spinning grains contains about 10 to about 50 wt % thermal-stable phase-change material.

12. Melt-spinning grains containing a thermal-stable phase-change material, comprising:
a micro-capsulated thermal-stable phase-change material comprising polyether fatty-acid ester which solid-liquid phase-change temperature is 0-80° C. and the maximum weight-loss temperature is higher than 350° C.;
a melt-spinning polymer; and
a dispersion agent.

13. The melt-spinning grains containing a thermal-stable phase-change material of claim 12, wherein the polyether main chain of the polyether fatty-acid ester is polyethylene glycol or polytetramethylene glycol.

14. The melt-spinning grains containing thermal-stable phase-change material of claim 12, wherein the molecular weight of the polyethylene glycol is from about 200 to about 20,000 g/mole.

15. The melt-spinning grains containing thermal-stable phase-change material of claim 12, wherein the molecular weight of the polytetramethylene glycol is from about 650 to about 3,000 g/mole.

16. The melt-spinning grains containing thermal-stable phase-change material of claim 12, wherein each of the two fatty acyl terminals of the polyether fatty-acid ester contains 4-28 carbons.

17. The melt-spinning grains containing thermal-stable phase-change 10 material of claim 12, wherein each of the two fatty acyl terminals of the polyether fatty-acid ester is stearoyl group, palmitoyl group, or lauroyl group.

18. The melt-spinning grains containing thermal-stable phase-change material of claim 12, wherein the melt-spinning polymer is polypropylene, polyethlyne, acrylic resin, thermoplastic polyurethane, nylon, or polyester.

19. The melt-spinning grains containing thermal-stable phase-change material of claim 12, wherein the dispersion agent includes lubricant.

20. The melt-spinning grains containing thermal-stable phase-change material of claim 12, wherein the weight ratio for the micro-capsulated thermal-stable phase-change material, the melt-spinning polymer and the dispersion is 10-50:40-90:0.5-5.
